(19) United States
(12) Patent Application Publication
(10) Pub. No.: US 2008/0281052 A1
(43) Pub. Date: Nov. 13, 2008

(54) MULTIPURPOSE RESIN COMPOSITION AND PROCESS FOR MANUFACTURING THE SAME

(75) Inventor: Richard M. Strand, Hampstead, NH (US)

Correspondence Address: FAY SHARPE LLP, 1100 SUPERIOR AVENUE, SEVENTH FLOOR, CLEVELAND, OH, 44114, US

(73) Assignee: Impact Matrix Systems, LLC

(21) Appl. No.: 12/117,162

(22) Filed: May 8, 2008

Related U.S. Application Data
(60) Provisional application No. 60/917,127, filed on May 10, 2007.

(51) Int. Cl. C08G 63/91; C08L 67/02

(52) U.S. Cl. 525/437

(57) ABSTRACT

A multipurpose process resin formulation which produces superior adhesion on a variety of different substrates including, but not limited to, carbon and aramid fibers. The resin formulation includes a mixture of a thermosetting polyester and or vinyl ester resin; a polymerizable and,or non-polymerizable phosphate ester phosphite ester and/or oligomer; and a curing and or catalyzing agent. The resin formulation can include an alkyl acrylate and/or methacrylate monomer and/or compound.

The present invention claims priority on U.S. Provisional Patent Application Ser. No. 60/917,127 filed May 10, 2007 entitled “Multipurpose Resin Composition and Process for Manufacturing the Same”, which is fully incorporated by reference herein.

The present invention relates to resin compositions, particularly to resin compositions that include thermosetting polyester and/or vinyl ester resins, phosphate and/,or phosphite ester compounds, more particularly to resin compositions that include unsaturated thermosetting polyester and/or vinyl ester resins, phosphate and/or phosphite ester compounds, and even more particularly to resin compositions that include unsaturated thermosetting polyester and/or vinyl ester resins, phosphate and/or phosphite ester compounds, and alkyl acrylate and/or methacrylate monomers.

### BACKGROUND OF THE INVENTION

Present day commercially available carbon fibers are supplied with two general types of sizing. First there are those based on vinyl ester polymer that is polymerized on the surface of the carbon fiber from a water based formulation. Secondly, there are also those based on epoxy polymers applied in a similar fashion. The interface formed between epoxy based matrices and epoxy sized carbon fibers generally exhibit a good level of adhesion returning moderate to high interlaminar and interply shear strength levels. However, the interface formed between vinyl ester sized carbon fibers and the vinyl ester resin matrix have been shown to exhibit low interfacial adhesion, thus negatively affecting interlaminar/interply shear strength and compression properties.

The problem associated with the poor interface that forms between vinyl ester sized carbon fibers and the vinyl ester resin matrix is experienced during resin injection and infusion, as well as in hand lamination processes. Infusion and injection resins are typically formulated to yield low viscosity levels to support reinforcement “flow through” and rapid “wet out”. Such vinyl ester resins may exhibit viscosity levels as low as 50 centipoise (cP @20°), making them work extremely well for large parts with heavy wall thicknesses. On the other hand, such large structures typically generate high compressive and shear loads that occur due to self weight and externally applied loads. Such materials may be used to construct structures such as light weight marine craft and large ship superstructures wherein the weight of several floors are acted upon by dynamic loads imposed by heavy seas that can create large compression and shear stresses. The generally low performance of commercially available vinyl ester sized carbon fibers hinders both the carbon and the vinyl ester resin system from consideration in such marine applications.

Epoxy sized fibers and epoxy matrices generally produce acceptable properties for marine applications. Such epoxy sized fibers and epoxy matrices are more difficult to use in the infusion process because of the nature of the epoxy molecular chain. As such, epoxy sized fibers and epoxy matrices do not process well with respect to flow, spraying or wetting, thus making the epoxy sized fibers and epoxy matrices difficult to use in the infusion of large and thick walled parts. In addition, there are difficulties associated with the low glass transition temperatures resulting from room temperature cured epoxy matrices. These difficulties can result in the need for either higher temperature curing systems or extensive post-curing of large parts to yield an acceptable glass transition temperature. Both of these requirements can add significant cost, and make consistency of mechanical performance difficult.

In view of the current state of the art, there is a need for a resin formulation base on polyester and/or vinyl ester resins that can bond well to various type of surfaces such as, but not limited to, carbon fibers, aramid fibers, glass fibers, metals and/or ceramics.

### SUMMARY OF THE INVENTION

The present invention is directed to resin compositions that include thermosetting unsaturated polyester resins that overcomes the adhesion problems associated with past polyester and/or vinyl ester resin formulations. Various types of vinyl ester resins, that can be used in the present invention, are disclosed in U.S. Pat. Nos. 3,564,074; 4,151,219; 4,347,343; 4,472,544; 4,483,963; 4,824,919; 3,548,030, and 4,197,390. Vinyl ester resins typically comprise a terminally unsaturated vinyl ester resin, generally derived from a polyepoxide, and at least one copolymerizable monomer (e.g., styrene, etc.). The terminally unsaturated vinyl ester resins are typically prepared by reacting about equivalent proportions of a polyepoxide (e.g., a bisphenol A/epichlorohydrin adduct, etc.) with an unsaturated monocarboxylic acid (e.g., acrylic acid, methacrylic acid, etc.). The present invention provides a solution to the adhesion shortcomings resulting from poor interface that forms between past unsaturated polyester resin formulations and various types of fibers such as, but not limited to, carbon fibers and aramid fibers. The present invention is in general related to resin compositions, particularly to resin compositions that include thermosetting unsaturated polyester resins and phosphate and/or phosphite ester compounds, more particularly to resin compositions that include unsaturated thermosetting polyester and/or vinyl ester resins, phosphate and/or phosphite ester compounds, and even more particularly to resin compositions that include unsaturated thermosetting polyester and/or vinyl ester resins, phosphate and/or phosphite ester compounds, and alkyl acrylate and/or methacrylate monomers.

The use of strong oxidizers on the surface of carbon fiber can enhance the ability of the carbon fibers to adhere to certain types of resin matrices. The oxidized state of the fiber surface, once generated, typically needs to be preserved to achieve the desired bond of the resin matrices to the carbon fibers, since it is believed that the oxidized state of the carbon fiber surface is unstable. It is believed that oxygen complexing with the carbon surface of the carbon fibers is the means by which enhanced adhesion results between the carbon fibers and resin matrices.

Oxygen reactions with the carbon surface have been studied extensively in several different areas of technology. Some of these studies include storage devices for the fuel cell industry, carbon nanotubes, and technologies in the coal burning environmental industry. In the process of developing oxygen complexes on the carbon fiber surface, oxygen is first chemisorbed on an electron rich site of the carbon basal plane, and then dissociates into oxygen atoms. Oxygen will diffuse on the carbon fiber surface until the oxygen finds locations where it can form structural (covalent) bonds with the carbon. These bonding sites are usually locations where a structural defect in the carbon exists. In carbon structures, unsaturated atoms at the edges of its many varied surfaces can form covalent bonds with oxygen. Such locations will directly chemisorb oxygen to form carbon-oxygen complex bonds. Depending on the efficiency of the carbonization process, nitrogen may also be present within the carbon structures, especially at the edges. The reactions of oxygen with such locations that include nitrogen are less understood.

Manufacturers of advanced, high strength carbon fiber types (e.g., T300, T500, T700, etc.) can control the carbonization process to obtain stronger carbon fibers. It is known that the strength of T300 fibers increases from 2.2 to 3.2 Gpa after heat treatment to 2800° F. Such heat treatment under tension increases carbon cyclization and eliminates nitrogen from the carbon fiber. As such, this carbonization process produces a more perfect cyclized structure that is absent nitrogen to a greater extent than other commercially available carbon fibers. This more perfect cyclized structure for the carbon fiber is one reason why this type of fiber surface becomes difficult to adhere to. Another reason for difficult adhesion is from the use of vinyl ester polymer (VEP) (cross linked in the application process) as a sizing. Development of good adhesion to such surfaces often requires two mechanisms. The first mechanism is the solvation ofthe vinyl ester surface and the co-mingling of molecules at that location with the bonding resin. In this first mechanism, the styrene monomer in the bonding resin softens and partially dissolves the surface of the sizing. Molecules from the bonding resin co-mingle with those on the solvated sizing surface and re-cure with the cure of the bonding resin locking them together. These processes provide a mechanical lock of the two polymers at the molecular level. The second mechanism is the actual cross linking between the bonding resin and any unreacted double bonds on the vinyl ester sizing surface. Highly efficient application of vinyl ester sizing results in a high rate of conversion (cross linking) during cure in the sizing leaving few, if any, reactive sites for secondary cross linking. In addition, the resulting cured sizing is highly chemical resistant, thereby reducing its tendency to be solvated by the bonding resins (other polyesters and vinyl esters).

It is also generally known in the industry that many different techniques, to post-oxidize the carbon fiber surface, have been tested and to provide enhanced adhesion of different matrices at the fiber interface. The different techniques that have been tested include those applied in both liquid and gaseous environments. Hot air containing oxygen and nitrogen, as well as plasma-ionized inert gases have been tested. Direct wet techniques including the use of nitric acid, hyperchlorite and chlorate, as well as dichromate in sulfuric acid have also been tested. It is generally known in the industry that the strong oxygen complexes can form on the carbon fiber surface during these types of treatments. However, the lack of chemical stability of such oxygen complexes on the carbon fibers is one of the reason why carbon fiber manufacturers coat the prepared surface of the fiber with a polymer coating.

The surface of carbon fibers is a fairly imperfect structure. Because of the “tug of war” that exists in the processing variables of carbonization, imperfect cyclized structures result on the carbon fibers. The microtexture of the carbon fiber surface depends on a variety of variables affecting carbonization. There are trade offs between carbon fiber tensile strength and stiffness properties. The production of higher modulus carbon fibers requires higher heat treatment temperatures. Higher modulii results because the carbon fiber becomes more compact and the void spaces within the carbon fiber are smaller. The higher heat treatment temperatures for the carbon fibers promote the joining of oriented and touching layers of the carbon fibers, thus improving parallel alignment and compaction of the carbon in the carbon fibers. The carbon fiber surface comprises layers, folds and pores as illustrated in FIG. 1. Better carbon fiber properties have a reduced number of folds, pores and voids. However, such carbon fibers have a reduced amount of defect planes wherein oxygen complexing can occur.

When considering adhesion of a resin to carbon fibers, it is important to consider the molecular size of the materials that are to be in contact with the microtextural features of the carbon fiber that will be used to develop the adhesion with the carbon fibers.

The basic structure of a phosphate ester is shown as follows:

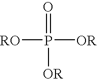

The phosphate esters (PE) are generally formed by the condensation reaction of phosphoric acid with the hydroxyl groups of alcohols. The R groups can be hydrogen and/or an organic radical. If the R group is an ester group with a double bond, such as methacrylate, the molecule becomes chemically reactive in the presence of a free radical. In the case of VER, the radical generator can be, but not limited to, a metal accelerated ketone peroxide with high active oxygen content and/or an amine activated di-acyl peroxide. As can be seen from the structure of PE, there is an ample supply of oxygen present for the formation of C—O complexes on the surface of carbon fibers. If the R groups on the phosphate ester comprises one or two hydrogen molecules and one or two ester groups, an essentially acidic species is formed which is capable of producing the desired oxygen complex associations with the carbon fiber surface as well as a reactive arm capable of cross-linking with the vinyl ester matrix. When all three of the R groups are hydrogen, the structure is orthophosphoric acid as shown as follows:

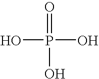

When the PE molecule (and ester side group) are too large, the molecule will not properly permeate the folds, layers and pores on the carbon fiber surface. It is believed that at the edges of the carbon fibers is the location that complexing of the PE molecule with the carbon fibers needs to occur.

In accordance with one non-limiting aspect of the present invention, the resin formulation of the present invention includes one or more unsaturated polyester resins. As defined herein, unsaturated polyester resins and resins that include one or more double bonds and are formed by the reaction of dibasic organic acids (e.g., dicarboxylic acid) and polyhydric alcohols (e.g., dihydroxy alcohol). Non-limiting acids that can be used to form the unsaturated polyester resins include, but are not limited to, maleic acid, fumaric acid, phthalic acid, and/or adipic acid. As can be appreciated, anhydrides of one or more of these acids can be used. Non-limiting polyhydric alcohols that can be used include, but are not limited to, ethylene glycol, propylene glycol, and/or diethylene glycol. Cross-linking agents that can be used to form the unsaturated polyester resins include, but are not limited to, styTene, styrene monomer, xylene, xylene monomer, toluene, toluene monomers, benzene monomers, acrylate monomer, isophthalic acid, orthophthalic acid, terephthalic acid and/or diallyl phthalate. The one or more unsaturated polyester resins used in the present invention are typically a thermosetting plastic. Non-limiting unsaturated polyester resins that can be used include, but are not limited to, vinyl ester resins, dicyclopentadiene (DCPD) plastic resin, ABS thermoplastic resin, acetal (POM) copoly thermoplastic resin, acrylic thermoplastic resin, ASA thermoplastic resin, PP copoly thermoplastic resin, HDPE thermoplastic resin, PP homopoly thermoplastic resin, PS (HIPS) thermoplastic resin, LDPE thermoplastic resin, Nylon 6 thermoplastic resin, Nylon 66 thermoplastic resin, Nylon 66/6 thermoplastic resin, Nylon 46 thermoplastic resin, Nylon 12 thermoplastic resin, Nylon 11 thermoplastic resin, Nylon 610 thermoplastic resin, Nylon 612 thermoplastic resin, PET thermoplastic resin, PC thermoplastic resin, SAN thermoplastic resin, PBT thermoplastic resin, PPA thermoplastic resin, TPU thermoplastic resin, PETG thermoplastic resin, TPE thermoplastic resin, PPS thermoplastic resin, PES thermoplastic resin, PAS thermoplastic resin, PPE thermoplastic resin, PSU thermoplastic resin, polyarylate thermoplastic resin, TP thermoplastic resin, PET thermoplastic resin, PEEK thermoplastic resin, PEK thermoplastic resin, PUR thermoplastic resin, SEBS thermoplastic resin, SBS thermoplastic resin, TES thermoplastic resin, TPO thermoplastic resin, TPV thermoplastic resin, PAMXD6 thermoplastic resin, PMP thermoplastic resin, PFA thermoplastic resin, ETFE thermoplastic resin, PVDF thermoplastic resin, LCP thermoplastic resin, PAEK thermoplastic resin, PEKEKK thermoplastic resin, PI thermoplastic resin, SPS thermoplastic resin, PTT thermoplastic resin, SAN thermoplastic resin, PE thermoplastic resin, PIT thermoplastic resin, and any combination ofthe aforementioned thermoplastic resins. Only one type ofunsaturated polyester resin can be included in the resin formulation, or a plurality of different unsaturated polyester resins can be used in the resin formulation. In one non-limiting embodiment of the invention, the total amount of unsaturated polyester resin included in the resin formulation is generally at least about 1 weight percent, and generally up to about 99.99 weight percent. In one non-limiting aspect of this embodiment, the total amount of unsaturated polyester resin included in the resin formulation is about 10 to 99.9 weight percent. In another and/or alternative non-limiting aspect of this embodiment, the total amount of unsaturated polyester resin included in the resin formulation is about 30 to 99.9 weight percent. In still another and/or alternative non-limiting aspect ofthis embodiment, the total amount of unsaturated polyester resin included in the resin formulation is about 40 to 99.9 weight percent. In yet another and/or alternative non-limiting aspect of this embodiment, the total amount of unsaturated polyester resin included in the resin formulation is about 50 to 99.9 weight percent. In still yet another and/or alternative non-limiting aspect of this embodiment, the total amount of unsaturated polyester resin included in the resin formulation is about 60 to 99.9 weight percent. In another and/or alternative non-limiting aspect of this embodiment, the total amount of unsaturated polyester resin included in the resin formulation is about 70 to 99.9 weight percent. In still another and/or alternative non-limiting aspect of this embodiment, the total amount of unsaturated polyester resin included in the resin formulation is about 80 to 99.9 weight percent. In yet another and/or alternative non-limiting aspect of this embodiment, the total amount of unsaturated polyester resin included in the resin formulation is about 85 to 99.9 weight percent. In still yet another and/or alternative non-limiting aspect of this embodiment, the total amount of unsaturated polyester resin included in the resin formulation is about 90 to 99.9 weight percent. In another and/or alternative non-limiting aspect of this embodiment, the total amount of unsaturated polyester resin included in the resin formulation is about 90 to 99 weight percent. In still another and/or alternative non-limiting aspect of this embodiment, the total amount of unsaturated polyester resin included in the resin formulation is about 92 to 99 weight percent. In yet another and/or alternative non-limiting aspect of this embodiment, the total amount of unsaturated polyester resin included in the resin formulation is about 93 to 98 weight percent. As can be appreciated, other weight percentages of the total amount unsaturated polyester resin included in the resin formulation can be used. In another and/or alternative non-limiting embodiment of the invention, the average viscosity of the unsaturated polyester resin is generally less than about 1000 cP@20° C. An average viscosity that is greater than 1200 cP@20° C. can result in difficult or unsatisfactory application of the resin formulation onto various types of surfaces and/or desired infusion of fibers. In one non-limiting aspect of this embodiment, the average viscosity of the unsaturated polyester resin in the resin formulation is up to about 1000 cP@20° C. In another and/or alternative non-limiting aspect of this embodiment, the average viscosity of the unsaturated polyester resin in the resin formulation is up to about 800 cP@20° C. In still another and/or alternative non-limiting aspect of this embodiment, the average viscosity of the unsaturated polyester resin in the resin formulation is up to about 600 cP@20° C. In yet another and/or alternative non-limiting aspect ofthis embodiment, the average viscosity of the unsaturated polyester resin in the resin formulation is up to about 400 cP@20° C. In still yet another and/or alternative non-limiting aspect of this embodiment, the average viscosity of the unsaturated polyester resin in the resin formulation is up to about 200 cP@20° C. In another and/or alternative non-limiting aspect of this embodiment, the average viscosity of the unsaturated polyester resin in the resin formulation is up to about 100 cP@20° C. In still another and/or alternative non-limiting aspect of this embodiment, the average viscosity of the unsaturated polyester resin in the resin formulation is at least about 10 cP@20° C. As can be appreciated, other average viscosities of the unsaturated polyester resin in the resin formulation can be used.

In accordance with another and/or alternative non-limiting aspect of the present invention, the use of phosphate and/or phosphite esters as a direct additive to VER can be used to provide adequate proximity and quantity of the PE to the carbon fiber surface to yield dramatic improvements in adhesion between the matrix and carbon fiber surface. This has been found to be true for both the VEP sized fibers as well as the unsized fiber. In one non-limiting embodiment of the invention, the phosphate or phosphite ester can also be bound with a VER soluble polymer and deposited on the carbon fiber surface as a sizing to produce the desired adhesion improvement. In another and or alternative non-limiting embodiment ofthe invention, the phosphate and/or phosphite esters that can be used in the resin formulation can be any R-group on the phosphoric acid that can react or form a double bond with a methacrylate, acrylate, and/or polyester (e.g., methacrylate phosphoric acid ester). Non-limiting phosphate and/or phosphite esters that can be used include, but are not limited to, phosphate polyether ester, methyl phosphate and/or phosphite, dimethyl phosphate and/or phosphite, trimethyl phosphate and/or phosphite, isopropyl phosphate and/or phosphite, ethyl phosphate and/or phosphite, diethyl phosphate and/or phosphite, triethyl phosphate and/or phosphite, butyl phosphate and/or phosphite, dibutyl phosphate and/or phosphite, tributyl phosphate and/or phosphite, and any combination of the aforementioned ester phosphates and/or ester phosphites. In another and/or alternative one non-limiting embodiment of the invention, the phosphate esters that can be used in the present invention can be formed from alkyl diaryl phosphates and/or triaryl phosphates, and phosphate solvent species carry the following R1, R2 and R3 substitutes: C6-10-alkyl, C1-4-alkylaryl, C1-4-alkoxy-C1-4-alkyl and C1-4-alkoxyaroyl. A single type of phosphate or phosphite ester can be used in the resin formulation, or a mixture of phosphate and/or phosphite esters can be used in the resin mixture. When a plurality of phosphate and/or phosphite esters are included in the resin formulation, the same type of esters can be used (e.g., all phosphate ester, all phosphite esters) or a mixture can be used (at least one phosphate ester and at least one phosphite ester). In still another and/or alternative non-limiting embodiment of the invention, the total amount of phosphate and or phosphite ester included in the resin formulation is generally at least about 0.1 weight percent, and generally up to about 70 weight percent. In one non-limiting aspect of this embodiment, the total amount of phosphate and/or phosphite ester included in the resin formulation is about 0.1 to 60 weight percent. In another and/or alternative non-limiting aspect of this embodiment, the total amount ofphosphate and/or phosphite ester included in the resin formulation is about 0.1 to 50 weight percent. In still another and/or alternative non-limiting aspect of this embodiment, the total amount of phosphate and/or phosphite ester included in the resin formulation is about 0.1 to 40 weight percent. In yet another and/or alternative non-limiting aspect of this embodiment, the total amount of phosphate and/or phosphite ester included in the resin formulation is about 0.5 to 40 weight percent. In still yet another and/or alternative non-limiting aspect of this embodiment, the total amount of phosphate and/or phosphite ester included in the resin formulation is about 0.5 to 30 weight percent. In another and/or alternative non-limiting aspect of this embodiment, the total amount of phosphate and/or phosphite ester included in the resin formulation is about 0.5 to 20 weight percent. In still another and/or alternative non-limiting aspect of this embodiment, the total amount of phosphate and/or phosphite ester included in the resin formulation is about 0.5 to 15 weight percent. In yet another and/or alternative non-limiting aspect of this embodiment, the total amount of phosphate and/or phosphite ester included in the resin formulation is about 0.5 to 10 weight percent. In still yet another and/or alternative non-limiting aspect of this embodiment, the total amount ofphosphate and/or phosphite ester included in the resin formulation is about 0.5 to 8 weight percent. In another and/or alternative non-limiting aspect ofthis embodiment, the total amount of phosphate and/or phosphite ester included in the resin formulation is about 0.5 to 5 weight percent. In another and/or alternative non-limiting aspect of this embodiment, the total amount of phosphate and/or phosphite ester included in the resin formulation is about 0.75 to 4 weight percent. As can be appreciated, other weight percentages of the total amount of phosphate and or phosphite ester included in the resin formulation can be used.

In still another and/or alternative non-limiting aspect of the invention, the resin formulation can include one or more acrylate and/or methacrylate monomers and/or compounds; however, this is not required. The inclusion of one or more acrylate and/or methacrylate monomers and/or compounds in the resin formulation, when used, has been found to promote adhesion on a variety of surfaces. In one non-limiting embodiment of the invention. the acrylate and/or methacrylate monomers include an acrylate-based or methacrylate-based material, such as an ester monomer. Such reactants are generally the reaction products of acrylic and/or methacrylic acids with one or more mono- or polybasic, substituted or unsubstituted, alkyl (C1-18), aryl, aralkyl. and/or heterocyclic alcohols. The ester monomers can be, but not limited to, alkyl monomers (e.g, C1-4 alkyl esters, etc.). In another and/or alternative non-limiting embodiment of the invention, the acrylate and/or methacrylate monomers and/or compounds that can be used in the resin formulation include, but are not limited to, methacrylic acid, 1,10-decanediol dimethacrylate, 1,4-butanediol dimethacrylate, 1,6-hexanediol dimethacrylate, 1,9-decanediol dimethacrylate, ethyleneglycol dimethacrylate, 2-hydroxy-3-acryloxy propyl methacrylate, 2-hydroxybutyl methacrylate, 2-hydroxy propyl methacrylate, 2-phenoxy ethyl methacrylate, alkyl (C2-15) Methacrylate, benzyl methacrylate, behenyl methacrylate, cyclohexyl methacrylate, diethyleneglycol dimethacrylate, diethylaminoethyl methacrylate, Dimethacrylate of Ethylene Oxide Modified Bisphenol A, dimethylaminoethyl methacrylate, glycerin dimethacrylate, glycidyl methacrylate, isobornyl methacrylate, methoxy polyethyleeglycol methacrylate, methoxy triethyleneglycol methacrylate, n-butoxy ethyl methacrylate, neopentyl dimethacrylate, lauryl methacrylate, stearyl methacrylate, dimethacrylate, perfluorooctylethyl methacrylate, t-butyl methacrylate, tetrahydrofurfuryl methacrylate, ethylene ureaethyl methacrylate, methyl methacrylate, 4-tert-Butylcyclohexyl methacrylate, 2-ethyhexyl methacrylate, allyl methacrylate, propyl acrylate, butyl methacrylate, ethyl methacrylate, isobutyl methacrylate, methyl methacrylate, 2-ethyl hexyl acrylate, 2-hydroxyethyl acrylate, butyl acrylate, ethyl acrylate, methyl acrylate, hexylacrvlate, hydroxyethyl methacrylate, hydroxyethyl acrylate, propyl methacrylate, hydroxypropyl methacrylate, hydroxypropyl acrylate, hexafluoroisopropyl acrylate, dimethyl aminoethyl acrylate, allyl acrylate, 2-ethylhexyl methacrylate, and any mixtures of the aforementioned compounds. In one non-limiting aspect of this embodiment, the acrylate and/or methacrylate monomers and or compounds that can be used in the resin formulation includes, but is not limited to, methyl methacrylate. laurel methacrylate, stearyl methacrylate, butyl acrylate and or methacrylic acid. A single type of acrylate and/or methacrylate monomers and/or compounds can be used in the resin formulation, or a mixture of acrylate and/or methacrylate monomers and/or compounds can be used in the resin mixture. When a plurality of acrylate and/or methacrylate monomers and/or compounds are included in the resin formulation, the same type of compound can be used (e.g., all acrylate monomer or compounds, all methacrylate monomers or compounds) or a mixture can be used (at least one acrylate monomer and/or compound and at least one methacrylate monomer and/or compound). In another and/or alternative non-limiting embodiment of the invention, the total amount of acrylate and/or methacrylate monomer and/or compound included in the resin formulation is generally at least about 0.1 weight percent, and generally up to about 50 weight percent. In one non-limiting aspect of this embodiment, the total amount of acrylate and/or methacrylate monomer and/or compound included in the resin formulation is about 0.1 to 40 weight percent. In another and/or alternative non-limiting aspect of this embodiment, the total amount of acrylate and/or methacrylate monomer and/or compound included in the resin formulation is about 0.1 to 30 weight percent. In still another and/or alternative non-limiting aspect ofthis embodiment, the total amount of acrylate and/or methacrylate monomer and/or compound included in the resin formulation is about 0.1 to 20 weight percent. In yet another and/or alternative non-limiting aspect of this embodiment, the total amount of acrylate and/or methacrylate monomer and/or compound included in the resin formulation is about 0.1 to 15 weight percent. In still yet another and/or alternative non-limiting aspect ofthis embodiment, the total amount of acrylate and/or methacrylate monomer and/or compound included in the resin formulation is about 0.1 to 10 weight percent. In another and/or alternative non-limiting aspect ofthis embodiment, the total amount of acrylate and/or methacrylate monomer and/or compound included in the resin formulation is about 1 to 8 weight percent. In still another and/or alternative non-limiting aspect of this embodiment, the total amount of acrylate and/or methacrylate monomer and/or compound included in the resin formulation is about 1 to 4 weight percent. As can be appreciated, other weight percentages of the total amount of acrylate and/or methacrylate monomer and or compound included in the resin formulation can be used.

In still yet another and/or alternative non-limiting aspect of the invention, one or more components of the resin formulation can be cured and/or catalyzed using an amine, a metal initiator and/ or an organic peroxide. Non-limiting examples of such curing and/or catalyzing agents include, but are not limited to, amine compounds (N,N-dimethylaniline (DMA), N,N-dimethyl-p-toluidine (DMPT),-methyl-N-hydroxyethyl-p-toluidine (MHPT), hydroxyethyl toluidine, N,N-diethyl aniline (DEA), ethyl benzyl aniline (EBA),-ethyl aniline (MEA), N-methyl aniline (MMA), dimethyl analine, dihydro pyridine, etc.), peroxide compounds (e.g., methyl ethyl ketone peroxide, diacyl peroxide [e.g., benzoyl peroxide (BPO)], cumene hydroperoxide, tertiary butyl hydroperoxide, dicumyl peroxide, etc.), tertiary butyl perbenzoate, and/or metal compounds (e.g., copper acetyl acetonate, etc.). One or more curing and/lor catalyzing agents can be used to promote the curing of one or more components of the resin formulation (e.g., unsaturated polyester resin, phosphate ester, phosphite ester, etc.). If more than one curing and/or catalyzing agent is used, the plurality of curing and/or catalyzing agents can be the same type (e.g., all amines, all peroxides, all metal compounds), or can be some mixture of two or more types of curing and/or catalyzing agents. In one non-limiting embodiment ofthe invention, the curing and/or catalyzing agent includes an amine/peroxide system.

Such a curing system has been found to produce radicals capable of activating the phosphate or phosphite ester in acceptable quantities. One non-limiting amine/peroxide system is an amine/diacyl peroxide system. In another and/or alternative non-limiting embodiment ofthe invention, the curing and/or catalyzing agent includes at least one amine compound and at least one metal initiator and/or peroxide compound. In one non-limiting composition, the curing and/or catalyzing agent includes at least one amine compound and at least one peroxide compound. In another non-limiting composition, the curing and/or catalyzing agent includes at least one amine compound, at least one peroxide compound and at least one metal compound. Such combination of curing and/or catalyzing agents has been found to produce the desired activation ofthe phosphate or phosphite ester molecule and curing of the unsaturated polyester resin in the resin formulation, thereby producing a multi-stage cure with fringe benefits. In addition or alternatively, when two or more curing and/or catalyzing agents are used, such combination can yield an intermediate gelation state in the curing resin matrix with an extended slow rise to exotherm, while keeping the generation of exothermic heat to lower values. For example, a high mass vinyl ester matrix composite with conventional cure technology might exotherm as high as 360° F. to 400° F., while the same resin matrix cured in accordance with the combination of curing agents or catalysts ofthe present invention will generally not exceed 300° F., typically will not exceed 250° F., more typically will not exceed 200° F., and even more typically will not exceed 190° F., in the same mass while still producing adequate green strength for part removal and handling with a high degree of conversion over a slightly longer period of time. In addition to activating the phosphate or phosphite ester for complexing with the carbon fiber surface, thick composites will yield a cooler and controlled cure. In still another and/or alternative non-limiting embodiment of the invention, the total amount of curing and/or catalyzing agent that is used generally constitutes at least about 0.01 weight percent of the total resin formulation, and generally does not exceed about 30 weight percent ofthe total resin formulation. In one non-limiting aspect ofthis embodiment, the total amount of curing and/or catalyzing agent that is used constitutes about 0.01 to 25 weight percent of the total resin formulation. In another and/or alternative non-limiting aspect of this embodiment, the total amount of curing and/or catalyzing agent that is used constitutes about 0.01 to 20 weight percent of the total resin formulation. In still another and/or alternative non-limiting aspect of this embodiment, the total amount of curing and/or catalyzing agent that is used constitutes about 0.01 to 15 weight percent of the total resin formulation. In yet another and/or alternative non-limiting aspect of this embodiment, the total amount of curing and/or catalyzing agent that is used constitutes about 0.01 to 10 weight percent of the total resin formulation. In yet another and/or alternative non-limiting aspect of this embodiment, the total amount of curing and/or catalyzing agent that is used constitutes about 0.05 to 5 weight percent of the total resin formulation. In still yet another and,or alternative non-limiting aspect of this embodiment, the total amount of curing and/or catalyzing agent that is used constitutes about 0.1 to 5 weight percent of the total resin formulation. In another and/or alternative non-limiting aspect of this embodiment, the total amount of curing and/or catalyzing agent that is used constitutes about 0.2 to 5 weight percent of the total resin formulation. In still another and/or alternative non-limiting aspect ofthis embodiment, the total amount of curing and/or catalyzing agent that is used constitutes about 0.2 to 4.5 weight percent of the total resin formulation. In yet another and/or alternative non-limiting aspect of this embodiment, the total amount of curing and or catalyzing agent that is used constitutes about 0.5 to 4.5 weight percent of the total resin formulation. In still yet another and/or alternative non-limiting aspect of this embodiment, the total amount of curing and/or catalyzing agent that is used constitutes about 1 to 4.5 weight percent of the total resin formulation. As can be appreciated, other weight percentages of the curing and/or catalyzing agent in the resin formulation can be used.

In another andi/or alternative non-limiting aspect of the present invention, the activated PE molecule can promote a much higher degree of adhesion between unsaturated polyesters (e.g., vinyl ester and/or polyester matrices that are based on orthophthallic, isophthallic and terephthalic acids, etc.) and a broad variety of substrates including aramid fibers, aluminum, stainless steel, secondarily bonded composite surfaces, damp composite surfaces, stone, cement and a wide variety of masonry products.

It is one non-limiting object of the present invention to provide a multipurpose/process resin composition that has improved adhesion to fibers such as, but not limited to, carbon fibers and aramid fibers.

It is another andi/or alternative non-limiting object of the present invention to provide a multipurpose/process resin composition that has good adhesion to aluminum, stainless steel, secondarily bonded composite surfaces, damp composite surfaces, stone, cement and a wide variety of masonry products.

It is still another and/or alternative non-limiting object of the present invention to provide a multipurpose/process resin composition that includes thermosetting unsaturated polyester resin, a phosphate and/or phosphite ester, and a curing agent and/or catalyst.

It is yet another and/or alternative non-limiting object of the present invention to provide a multipurpose/process resin composition that includes thermosetting unsaturated polyester resin, and a curing agent and/or catalyst that includes a metal initiator, a peroxide and/or an amine.

It is still yet another and/or alternative non-limiting object ofthe present invention to provide a multipurpose process resin composition that includes unsaturated polyester resin, a phosphate and/,or phosphite ester, and a curing agent and/or catalyst that includes a metal initiator, a peroxide and/or an amine.

It is another and/or alternative non-limiting object of the present invention to provide a multipurpose/process resin composition that includes thermosetting unsaturated polyester resin, a phosphate and/or phosphite ester, an acrylate and/or methacrylate monomer and/or compound, and a curing agent and/or catalyst.

It is still another andi/or alternative non-limiting object of the present invention to provide a multipurpose/process resin composition that includes thermosetting unsaturated polyester resin, a phosphate and/or phosphite ester, an acrylates and/or methacrylate monomer and/or compound, and a curing agent and/or catalyst that includes a metal initiator, a peroxide and/or an amine.

These and other objects and advantages will become apparent to those skilled in the art upon reading and following the description taken together with the accompanying drawing.

### BRIEF DESCRIPTION OF THE DRAWING

FIG. 1 illustrates a carbon fiber surface that includes layers, folds and pores.

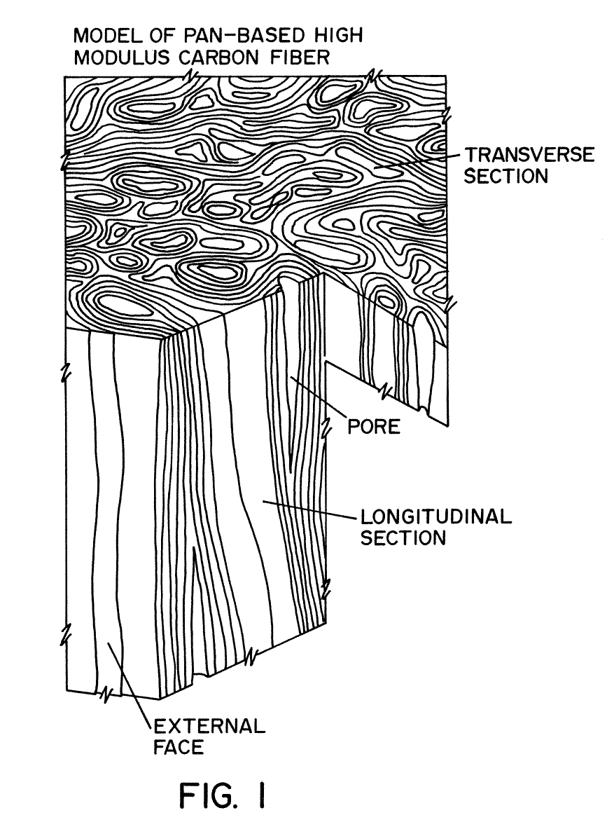

### DETAILED DESCRIPTION OF THE PREFERRED EMBODIMENT

The invention is directed to a novel resin formulation that includes one or more unsaturated polyesters and one or more phosphate and/or phosphite esters, which novel resin formulation has improved the adhesion to various surfaces such as, but not limited to carbon fibers, aramid fibers, aluminum, stainless steel, secondarily bonded composite surfaces, damp composite surfaces, stone, cement and a wide variety of masonry products.

The novel resin formulation generally constitutes at least about 30 weight percent unsaturated polyester resin, at least about 0.01 weight percent phosphate and/or phosphite ester. and at least about 0.01 weight percent curing agent and/or catalyst. The novel resin formulation can also include at least about 0.1 weight percent acrylate and/or methacrylate monomer and/or compound however, this is not required.

Non-limiting examples of the novel resin formulation in weight percent in accordance with the present invention are as follows:

### Example 1

| | |
|---|---|
| Unsaturated Polyester Resin | 40-99.9% |
| Phosphate and/or Phosphite Ester | 0.1-60% |
| Curing Agent or Catalyst | 0.01-20% |

### Example 2

| | |
|---|---|
| Unsaturated Polyester Resin | 60-99% |
| Phosphate and/or Phosphite Ester | 0.5-40% |
| Curing Agent or Catalyst | 0.01-15% |

### Example 3

| | |
|---|---|
| Unsaturated Polyester Resin | 60-99% |
| Phosphate and/or Phosphite Ester | 1-40% |
| Acrylate and/or Methacrylate | 0.1-40% |
| Monomer and/or Compound | |
| Curing Agent and/or Catalyst | 0.01-15% |

### Example 4

| | |
|---|---|
| Polyester and/or Vinyl Ester Resin | 60-99% |
| Phosphate and/or Phosphite Ester | 1-40% |
| Amine Promoter Compound | 0.05-15% |
| Peroxide Compound | 0.01-20% |

### Example 5

| | |
|---|---|
| Polyester and/or Vinyl Ester Resin | 80-99% |
| Phosphate and/or Phosphite Ester | 1-20% |
| Acrylate and/or Methacrylate | 0.2-20% |
| Monomer and/or Compound | |
| Curing Agent and/or Catalyst | 0.01-10% |

### Example 6

| | |
|---|---|
| Vinyl Ester Resin | 80-99% |
| Phosphate Ester | 1-20% |
| Amine Promoter Compound | 0.1-10% |
| Peroxide Compound | 0.01-10% |

### Example 7

| | |
|---|---|
| Vinyl Ester Resin | 85-99% |
| Phosphate Ester | 1-15% |
| Acrylate and/or Methacrylate | 0.5-15% |
| Monomer and/or Compound | |
| Peroxide Compound, Amine Compound | 0.01-10% |
| and/or Metal Compound | |

### Example 8

| | |
|---|---|
| Vinyl Ester Resin | 85-99% |
| Phosphate Ester | 1-15% |
| Amine Promoter Compound | 0.1-5% |
| Peroxide Compound | 0.01-10% |

### Example 9

| | |
|---|---|
| Vinyl Ester Resin | 85-98.5% |
| Phosphate Ester | 1-10% |
| Methacrylic Acid | 0.5-10% |
| Peroxide Compound, Amine Compound | 0.5-5% |
| and/or Metal Compound | |

### Example 10

| | |
|---|---|
| Vinyl Ester Resin | 85-98.5% |
| Phosphate Ester | 1-10% |
| N,N-dimethyl-p-toluidine | 0.1-1% |
| Benzoyl Peroxide | 0.25-5% |

### Example 11

| | |
|---|---|
| Vinyl Ester Resin | 90-98% |
| Phosphate Ester | 1-5% |
| Methacrylic Acid | 1-5% |
| Peroxide Compound, Amine Compound | 1-5% |
| and/or Metal Compound | |

### Example 12

| | |
|---|---|
| Vinyl Ester Resin | 92-98.5% |
| Phosphate Ester | 1-5% |
| N,N-dimethyl-p-toluidine | 0.1-0.8% |
| Benzoyl Peroxide | 0.5-4% |

### Example 13

| | |
|---|---|
| Vinyl Ester Resin | 90-98% |
| Phosphate Ester | 1-4% |
| Methacrylic Acid | 1-4% |
| Copper Acetylacetonate | 0.01-0.5% |
| Cumene Hydroperoxide | 0.1-3 |
| Phenyl Dihydro Pyridine | 0.1-4 |

In the above non-limiting examples, the unsaturated polyester resin is typically constitutes a majority weight percent of the resin formulation; however, this is not required. The viscosity of the unsaturated polyester resin can be selected to obtain the desired spreading and/or infusion properties ofthe resin formulation. Typically the viscosity ofthe unsaturated polyester resin is about 10-800 cP, more typically about 20-300 cP, and even more typically about 30-200 cP. The total weight percent of the unsaturated polyester resin in the resin formulation is typically greater than the total weight percent ofthe phosphate ester and/or phosphite ester in the resin formulation. Typically, the weight ratio of the total weight percent of unsaturated polyester resin to the total weight percent of phosphate ester and/or phosphite ester in the resin formulation is about 1.1 to 300, more typically about 2-200:1, even more typically about 10-150, still even more typically about 30-100:1, and yet even more typically about 31-97:1.

When one or more acrylate monomers, acrylate compounds, methacrylate monomers, and/or methacrylate compounds are included in the resin formulation, the total weight percent of unsaturated polyester resin in the resin formulation is typically greater than the total weight percent of the acrylate monomers, acrylate compounds, methacrylate monomers, and/or methacrylate compounds in the resin formulation. The weight percent ratio of the total weight percent of the unsaturated polyester resin in the resin formulation to the total weight percent of the acrylate monomers, acrylate compounds, methacrylate monomers, and/or methacrylate compounds in the resin formulation is about 1.1 to 300, more typically about 2-200:1, even more typically about 5-175, still even more typically about 10-150:1, and yet even more typically about 20-80:1. The weight percent ratio of the total weight percent of the acrylate monomers, acrylate compounds, methacrylate monomers, and/or methacrylate compounds in the resin formulation to the total weight percent of the phosphate ester and/or phosphite ester in the resin formulation is about 0.5-20:1, typically about 0.1-10:1, more typically about 0.2-5:1, even more typically about 0.3-3:1, and yet even more typically about 0.5-2:1.

The above examples form a unique unsaturated polyester resin that can bond to a variety of surfaces, including fiber surfaces on vinyl ester polymers. Heretofore, good bonding interfacial adhesion between vinyl ester polymer surface and prior art unsaturated polyester resins did not occur. The unique unsaturated polyester resin of the present invention overcomes the bonding issues associated with prior art unsaturated polyester resins. It has been found that the addition of acrylate and/or Methacrylate monomer and/or compound to unsaturated polyester results in a surprising strong bond being formed with vinyl ester polymer surfaces, includes vinyl ester polymer surfaces having carbon and/or aramid fibers.

The multipurpose resin formulation of the present invention produces superior adhesion on a variety of different substrates, including carbon and aramid fibers. This resin formulation can be useful for all thermosetting resins including all types of polyesters, vinyl esters and methacrylate monomer containing systems as such systems relate to the carbon and aramid fibers in composites. In addition, the resin formulation can be used as an adhesion promoter for all categories of substrates for thermosetting resins including all polyester and vinyl ester types.

It will thus be seen that the objects set forth above, among those made apparent from the preceding description, are efficiently attained, and since certain changes may be made in the composition set forth without departing from the spirit and scope of the invention, it is intended that all matter contained in the above description shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope ofthe present invention. It is also to be understood that the following claims are intended to cover all of the generic and specific features of the invention herein described and all statements of the scope of the invention, which, as a matter of language, might be said to fall therebetween.

I claim:

1. A resin formulation adhesion with a variety of surfaces, said resin formulation comprising up to about 99.9 weight percent unsaturated polyester resin and at least about 0.1 weight percent phosphate ester, phosphite ester, and mixtures thereof, said weight percent of said unsaturated polyester resin greater than said weight percent of said phosphate ester, phosphite ester, and mixtures thereof.

2. The resin formulation as defined in claim 1, wherein said weight percent of said unsaturated polyester resin constitutes a majority weight percent of said resin formulation.

3. The resin formulation as defined in claim 1, wherein a ratio of said weight percent of said unsaturated polyester resin to said weight percent phosphate ester, phosphite ester, and mixtures thereof is about 2-200:1.

4. The resin formulation as defined in claim 3, wherein a ratio of said weight percent of said unsaturated polyester resin to said weight percent phosphate ester, phosphite ester, and mixtures thereof is about 30-100:1.

5. The resin formulation as defined in claim 1, including an acrylate monomer, an acrylate compound, a methacrylate monomer, a methacrylate compound, and mixtures thereof.

6. The resin formulation as defined in claim 5, wherein a total weight percent in said resin formulation of said acrylate monomer, said acrylate compound, said methacrylate monomer, said methacrylate compound, and mixtures thereof constitutes at least about 0.1 weight percent.

7. The resin formulation as defined in claim 6, wherein a ratio of said weight percent of said total weight percent of said acrylate monomer, said acrylate compound, said methacrylate monomer, said methacrylate compound, and mixtures thereofto said weight percent phosphate ester, phosphite ester, and mixtures thereof is about 0.1-10:1.

8. The resin formulation as defined in claim 7, wherein a ratio of said weight percent of said total weight percent of said acrylate monomer, said acrylate compound, said methacrylate monomer, said methacrylate compound, and mixtures thereofto said weight percent phosphate ester, phosphite ester, and mixtures thereof is about 0.3-3:1.

9. The resin formulation as defined in claim 1, including a curing agent, a catalyst, and mixtures thereof, said curing agent, a catalyst, and mixtures thereof including an amine compound, a metal compound, a peroxide compound, and mixtures thereof.

10. The resin formulation as defined in claim 9, wherein said curing agent, said catalyst, and mixtures thereof including a plurality of compounds selected from the group consisting of an amine compound and a peroxide compound, a peroxide compound and a metal compound, or an amine compound and a peroxide compound and a metal compound.

11. The resin formulation as defined in claim 1, including by weight percent said resin formulation:

| | |
|---|---|
| Unsaturated Polyester Resin | 40-99.9% |
| Phosphate and/or Phosphite Ester | 0.1-60% |
| Curing Agent or Catalyst | 0.01-20% |

12. The resin formulation as defined in claim 1, including by weight percent said resin formulation:

| | |
|---|---|
| Unsaturated Polyester Resin | 60-99% |
| Phosphate and/or Phosphite Ester | 0.5-40% |
| Curing Agent or Catalyst | 0.01-15% |

13. The resin formulation as defined in claim 1, including by weight percent said resin formulation:

| | |
|---|---|
| Unsaturated Polyester Resin | 60-99% |
| Phosphate and/or Phosphite Ester | 1-40% |
| Acrylate and/or Methacrylate | 0.1-40% |
| Monomer and/or Compound | |
| Curing Agent and/or Catalyst | 0.01-15% |

14. The resin formulation as defined in claim 1, including by weight percent said resin formulation:

| | |
|---|---|
| Polyester and/or Vinyl Ester Resin | 60-99% |
| Phosphate and/or Phosphite Ester | 11-40% |
| Amine Promoter Compound | 0.05-15% |
| Peroxide Compound | 0.01-20% |

15. The resin formulation as defined in claim 1, including by weight percent said resin formulation:

| | |
|---|---|
| Polyester and/or Vinyl Ester Resin | 80-99% |
| Phosphate and/or Phosphite Ester | 1-20% |
| Acrylate and/or Methacrylate | 0.2-20% |
| Monomer and/or Compound | |
| Curing Agent or Catalyst | 0.01-10% |

16. The resin formulation as defined in claim 1, including by weight percent said resin formulation:

| | |
|---|---|
| Vinyl Ester Resin | 80-99% |
| Phosphate Ester | 1-20% |
| Amine Promoter Compound | 0.1-10% |
| Peroxide Compound | 0.01-10% |

17. The resin formulation as defined in claim 1, including by weight percent said resin formulation:

| | |
|---|---|
| Vinyl Ester Resin | 85-99% |
| Phosphate Ester | 1-15% |
| Acrylate and/or Methacrylate | 0.5-15% |
| Monomer and/or Compound | |
| Peroxide Compound, Amine Compound | 0.01-10% |
| and/or Metal Compound | |

18. The resin formulation as defined in claim 1, including by weight percent said resin formulation:

| | |
|---|---|
| Vinyl Ester Resin | 85-99% |
| Phosphate Ester | 1-15% |
| Amine Promoter Compound | 0.1-5% |
| Peroxide Compound | 0.01-10% |

19. The resin formulation as defined in claim 1, including by weight percent said resin formulation:

| | |
|---|---|
| Vinyl Ester Resin | 85-98.5% |
| Phosphate Ester | 1-10% |
| Methacrylic Acid | 0.5-10% |
| Peroxide Compound, Amine Compound | 0.5-5% |
| and/or Metal Compound | |

20. The resin formulation as defined in claim 1, including by weight percent said resin formulation:

| | |
|---|---|
| Vinyl Ester Resin | 85-98.5% |
| Phosphate Ester | 1-10% |
| N,N-dimethyl-p-toluidine | 0.1-1% |
| Benzoyl Peroxide | 0.25-5% |

21. The resin tormulation as defined in claim 1, including by weight percent said resin formulation:

| | |
|---|---|
| Vinyl Ester Resin | 90-98% |
| Phosphate Ester | 1-5% |
| Methacrylic Acid | 1-5% |
| Peroxide Compound, Amine Compound | 1-5% |
| and/or Metal Compound | |

22. The resin formulation as defined in claim 1, including by weight percent said resin formulation:

| | |
|---|---|
| Vinyl Ester Resin | 92-98.5% |
| Phosphate Ester | 1-5% |
| N,N-dimethyl-p-toluidine | 0.1-0.8% |
| Benzoyl Peroxide | 0.5-4% |

23. The resin formulation as defined in claim 1, including by weight percent said resin formulation:

| | |
|---|---|
| Vinyl Ester Resin | 90-98% |
| Phosphate Ester | 1-4% |
| Methacrylic Acid | 1-4% |
| Copper Acetylacetonate | 0.01-0.5% |
| Cumene Hydroperoxide | 0.1-3 |
| Phenyl Dihydro Pyridine | 0.1-4 |

24. A resin formulation adhesion with a variety of surfaces, said resin formulation comprising up to about 99.9 weight percent unsaturated polyester resin, at least about 0.1 weight percent phosphate ester, phosphite ester, and mixtures thereof, at least about 0.1 weight percent acrylate monomer, acrylate compound, methacrylate monomer, methacrylate compound, and mixtures thereof, and at least about 0.01 weight percent a curing agent, a catalyst, and mixtures thereof, said weight percent of said unsaturated polyester resin greater than a combined weight percent of said phosphate ester, phosphite ester, and mixtures thereof and said acyl ate monomer, said acrylate compound, said methacrylate monomer, said methacrylate compound, and mixtures thereof, a ratio of said weight percent of said unsaturated polyester resin to said weight percent phosphate ester, phosphite ester, and mixtures thereofis about 2-200:1, a ratio of said weight percent of said total weight percent of said acrylate monomer, said acrylate compound, said methacrylate monomer, said methacrylate compound, and mixtures thereofto said weight percent phosphate ester, phosphite ester, and mixtures thereof is about 0.1-10:1, said curing agent, a catalyst, and mixtures thereof including an amine compound, a metal compound, a peroxide compound, and mixtures thereof.

25. The resin formulation as defined in claim 24, wherein said unsaturated polyester resin constitutes a majority weight percent of said resin formulation.

26. The resin formulation as defined in claim 25, wherein a ratio of said weight percent of said unsaturated polyester resin to said weight percent phosphate ester, phosphite ester, and mixtures thereof is about 30-100:1.

27. The resin formulation as defined in claim 26, wherein a ratio of said weight percent of said total weight percent of said acrylate monomer, said acrylate compound, said methacrylate monomer, said methacrylate compound, and mixtures thereofto said weight percent phosphate ester, phosphite ester, and mixtures thereof is about 0.3-3:1.

28. The resin formulation as defined in claim 27, wherein said curing agent, said catalyst, and mixtures thereof including a plurality of compounds selected from the group consisting of an amine compound and a peroxide compound, a peroxide compound and a metal compound, or an amine compound and a peroxide compound and a metal compound.
